(19) United States
(12) Patent Application Publication
(10) Pub. No.: US 2017/0214719 A1
(43) Pub. Date: Jul. 27, 2017

(54) AUTO-CONFIGURATION AND MANAGEMENT OF STORAGE RESOURCES

(71) Applicant: HEWLETT PACKARD ENTERPRISE DEVELOPMENT LP, Houston, TX (US)

(72) Inventors: Rupin T Mohan, Littleton, MA (US); Vivek Agarwal, Littleton, MA (US); Krishna B Puttagunta, Roseville, CA (US)

(21) Appl. No.: 15/328,744

(22) PCT Filed: Sep. 9, 2014
(86) PCT No.: PCT/US2014/054774

§ 371 Date: Jan. 24, 2017

(51) Int. Cl. H04L 29/06; H04L 29/08

(52) U.S. Cl. CPC H04L 63/205; H04L 63/101; H04L 67/1097

(57) ABSTRACT

Examples relate to enabling auto-configuration and management of storage resources. In some examples, an Internet group management protocol (IGMP) announcement is received from an end device of a number of end devices in a software defined network (SDN) environment. A storage network fabric map is updated to include the end device based on the IGMP/multicast announcement, where the storage network fabric map describes a network topology of the end devices in the SDN environment. At this stage, a device port of the end device is added to a virtual local area network (ULAN). In response to determining that the end device matches a policy template, parameters of the template policy are applied to the device port.

### BACKGROUND

A storage area network (SAN) is a dedicated special-purpose network that interconnects different kinds of storage devices (e.g., storage, switches with associated data servers, etc.) to provide access to consolidated, block level data storage to various applications. Typically, such SAN's are managed by administrators using administrative utilities developed for specific SAN components.

### BRIEF DESCRIPTION OF THE DRAWINGS

The following detailed description references the drawings, wherein:

FIG. 1 is a block diagram of an example networking device for enabling auto-configuration and management of storage resources;

FIG. 2 is a block diagram of an example system for enabling auto-configuration and management of a software defined network;

FIG. 3 is a flowchart of an example method for execution by a networking device for enabling auto-configuration and management of storage resources; and

FIG. 4 is a flowchart of an example method for execution by a networking device for enabling auto-configuration and management of a software defined network.

### DETAILED DESCRIPTION

A software defined network (SDN) allows networking infrastructure to be centrally managed by an administrator. In an SUN network, the controller of network traffic (i.e., control plane) is separated from components that forward traffic (i.e., data plane). In this case, each traffic flow managed by the SUN controller is routed in the network by associating a forward action for the flow in every networking device on the flow path, Each forward action determines the networking device output port to be used for forwarding packets of that flow.

Typically, an SDN is unaware of SAN constructs such as zoning, quality of service, security policies, etc. for storage traffic. Accordingly, as discussed above, the SAN can be managed or configured by an administrator using administrative utilities, For example, when a server device is added, an administrator can manually configure the network configuration to add the end device to a storage-specific VLAN. Once added, the server device can access storage via the VLAN through the SDN controller.

In examples disclosed herein, a fabric aware SDN controller that supports Internet group management protocol (IGMP) multicasts to facilitate auto-configuration and management of the network fabric map. Specifically, end device networking ports can be managed by the SDN controller by applying template policy parameters such as zoning, quality of service, security policies, etc, based on attributes of the end devices. In this case, SDN controller includes an intelligent management module that can apply template policies to the network fabric, which is updated based on IGMP multicast port announcements directly from each end device in the storage area network.

Example embodiments disclosed herein provide efficient routing in SDN's. For example, in some embodiments, an Internet group management protocol (IGMP) announcement is received from an end device of a number of end devices. A storage network fabric map is updated to include the end device based on the IGMP/multicast announcement, where the storage network fabric map describes a network topology of the end devices in a software defined network (SDN). At this stage, a device port of the end device is added to a virtual local area network (VLAN). In response to determining that the end device matches a policy template, parameters of the template policy are applied to the device port.

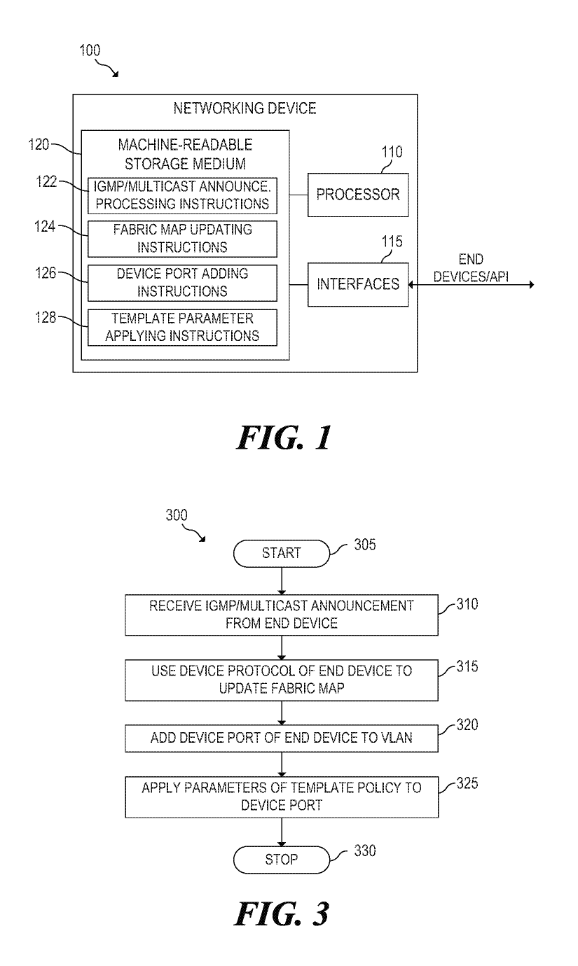

Referring now to the drawings, FIG. 1 is a block diagram of an example networking device 100 for enabling auto-configuration and management of storage resources. The example networking device 100 may be a switch, a router, a huh, a repeater, a bridge, or any other electronic device suitable for storage resources in a SDN. In the embodiment of FIG. 1, networking device 100 includes processor 110, in res 115, and machine-readable storage medium 120.

Processor 110 may be one or more central processing units (CPUs), microprocessors, and/or other hardware devices suitable for retrieval and execution of instructions stored in machine-readable storage medium 120. Processor 110 may fetch, decode, and execute instructions 122, 124, 126, 128 to enable auto-configuration arid management of storage resources, as described below. As an alternative or in addition to retrieving and executing instructions, processor 110 may include one or more electronic circuits comprising a number of electronic components for performing the functionality of one or more of instructions 122, 124, 126, 128.

Interfaces 115 may include a number of electronic components for communicating with end devices. For example, interfaces 115 may be wireless interfaces such as wireless local area network (WLAN) interfaces and/or physical interfaces such as Ethernet interfaces, Universal Serial Bus (USB) interfaces, external Serial Advanced Technology Attachment (eSATA) interfaces, or any other physical connection interface suitable for communication with end devices. In operation, as detailed below, interfaces 115 may be used to send and receive data to and from end devices.

Machine-readable storage medium 120 may be any electronic, magnetic, optical, or other physical storage device that stores executable instructions. Thus, machine-readable storage medium 120 may be, for example, Random Access Memory (RAM), Content Addressable Memory (CAM), Ternary Content Addressable Memory (TCAM), an Electrically-Erasable Programmable Read-Only Memory (EEPROM), flash memory, a storage drive, an optical disc, and the like. As described in detail below, machine-readable storage medium 120 may be encoded with executable instructions for enabling auto-configuration and management of storage resources.

IGMP/multicast announcement processing instructions 122 processes an IGMP/multicast announcement from an end device. IGMP is a communications protocol used by end devices and networking devices to facilitate multicast groups in a network, Once the multicast group is established where IGMP messages are being used, subsequent IGMP/multicast announcements are broadcast to each member of the multicast group. Specifically, IGMP/multicast announcement processing instructions 122 may receive an IGMP/multicast announcement and then extract parameters described for the end device that sent the IGMP/multicast announcement. Examples of attributes includes, but is not limited to, device type (e.g., storage device, networking device, server device, etc.), device protocols (e.g., fibre-channel over Ethernet (FCoE), Internet small computer system interface (i-SCSI), etc.), etc.

Fabric map updating instructions 124 updates a storage network fabric map based on the IGMP/multicast announcement. Specifically, the fabric map can be updated to include the end device based on the device protocol and/or type specified in the IGMP/multicast announcement. Because the device protocol is known, the fabric map can be automatically updated to accommodate the capabilities of the end device. For example, a server device and an associated application can be added to the fabric map for accessing storage connected to the data plane under an SON controller.

Device port adding instructions 126 segregates ports into groups, as an example, adds a device port of the end device to a VLAN. Subsets of ports can be specified for each device protocol. In this case, the device port of the end device is added to a corresponding VLAN based on the device protocol. For example a host or a storage array supporting FCoE can be added to an FCoE specific VLAN.

Template parameter applying instructions 128 applies policy template parameters to the device port of the end device. Examples of template parameters include, but are not limited to, quality of service, security, diagnostics, zoning profile, access control list (ACL), etc. The template parameters to be applied may be determined based on the template policy for the device protocol (i.e., each device protocol can be associated with a different template policy). Template parameter applying instructions 128 automatically updates the operating parameters of the device port as the end device is processed based on its announcements.

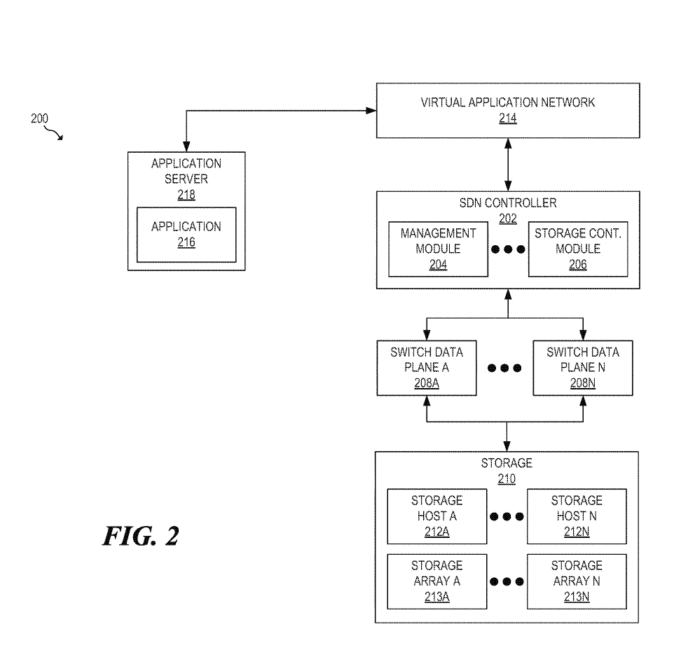

FIG. 2 is a block diagram of an example system 200 including SDN controller 202 interacting with application server 218 and storage 210 to provide a SDN. The components of SDN controller 202 may be similar to the corresponding components of networking device 100 described with respect to FIG. 1. System 200 also includes switch data planes 208A, 208N, and virtual application network (VAN) 214.

As illustrated, SDN controller 202 includes management module 204 and storage control module 206, which may be implemented as firmware (not shown). SDN controller 202 may also include a processor (not shown) and application programming interfaces (API's) (not shown). Processor and controlling functions may be similar to the corresponding components of networking device 100 that are described above with respect to FIG. 1. In this example, a north bound API can be used to communicate with application server 218 and storage 210 via switch data planes 208A, 208N. Each of the modules 204, 206 may include a series of instructions encoded on a machine-readable storage medium, which may be similar to machine-readable storage medium 120 of FIG. 1, and executable by processor. In addition or as an alternative, each module may include one or more hardware devices including electronic circuitry for implementing the functionality described below. Although the modules 204, 206 are described in detail below, additional details regarding an example implementation of the modules 204, 206 are provided above in connection with instructions 122-128 of FIG. 1.

Management module 204 is configured to handle IGMP communications from end devices. Specifically, IGMP/multicast announcements can be received from end devices and then used extracting attributes associated with the end devices from the announcements. Management module 204 can process each announcement to add a corresponding end device to an IGMP table. Further, registration of the corresponding end device can also be confirmed by further communications between management module 204 and the end device. Once the end device is confirmed, management module 204 may create a data entry for the end device in a fabric mapping data store (not shown). In this manner, end devices can be automatically identified and then queued up for processing by the storage control module 206 as described below.

Storage control module 206 processes data entries in the fabric mapping data store. Initially, each data entry can be processed to add an end device to a storage network fabric map based on the device protocol of the end device and to perform an appropriate action such as adding the device port associated with the end device to a storage specific VLAN. After the device port is added to the VLAN, attributes of the end device can be compared to template policies to find a matching policy. If storage control module 206 finds a matching policy, the parameters (e.g., quality of service, security, diagnostics, zoning profile, and access control list (ACL), etc.) of the matching policy can be applied to the device port.

In the case where the end device is an application server 218, storage control module 206 may also be configured to integrate an application 216 associated with the application server 218 to the storage network fabric map. In this manner, application 216 can be provided with additional capability to control/configure storage 210.

The modules 204, 206 described above are able to manage the storage network fabric map and the SAN configuration without the intervention of an administrator. Specifically, modules 204, 206 are able to automatically (1) segregate end devices into groups in response to IGMP/multicast announcements; (2) update the storage network fabric map to reflect any new end devices; and (3) add device ports and apply template policies based on the attributes of each end device.

Switch data planes 208A, 208N direct storage traffic to the appropriate storage device 213A-213N or 212A-212N of storage 210. One level of switch data planes 208A, 208N is shown; however, system 200 can include any number of levels of switch data planes. Storage arrays 213A, 213N can include various storage devices such as magnetic hard drives, solid state drives, high capacity random access memory, etc.

Each VLAN corresponds to a broadcast domain for a set of devices. System 200 can include multiple VLAN's. For example, system 200 can include an FCoE VLAN and an iSCSI VLAN to support multiple protocols sharing the same infrastructure. Each VLAN allows for IGMP broadcasts to be provided to the end devices and networking devices assigned to the VLAN. In this case, multiple SDN controllers (e.g., SDN controller 202) can be simultaneously notified of, for example, new end devices and react accordingly. Further, other end devices in a VLAN can also react to Multicast announcements when appropriate.

VAN 214 is configured to facilitate virtual application deployments. For example, VAN 214 can deploy application 216 on application server 218, where application 216 provides functionality such as load balancing, security, etc. that are enforced on switch data planes 208A, 208N by SDN controller 202.

FIG. 3 is a flowchart of an example method 300 for execution by a networking device 100 for enabling auto-configuration and management of storage resources. Although execution of method 300 is described below with reference to networking device 100 of FIG. 1, other suitable devices for execution of method 300 may be used such as SDN controller 202 of FIG. 2. Method 300 may be implemented in the form of executable instructions stored on a machine-readable storage medium, such as computer readable medium 120 of FIG. 1, and/or in the form of electronic circuitry.

Method 300 may start in block 305 and continue to block 310, where networking device 100 receives an IGMP/multicast announcement from an end device. Attributes (e.g., device type, device protocols, etc.) of the end device can he extracted from the IGMP/multicast announcement. The IGMP/multicast announcement signals that the end device wishes to join a Multicast group. In block 315, a storage network fabric map is updated based on the IGMP/multicast announcement. Specifically, the fabric map can be updated to include the end device based on the device protocol and/or type specified in the IGMP/multicast announcement.

In block 320, a device port of the end device is added to a storage specific VLAN managed by computing device 100. The device port of the end device is added to the corresponding VLAN based on the device protocol. In block 325, a policy template is applied to the device port of the end device according to the device protocol. Method 300 may then continue block 330, where method 300 may stop.

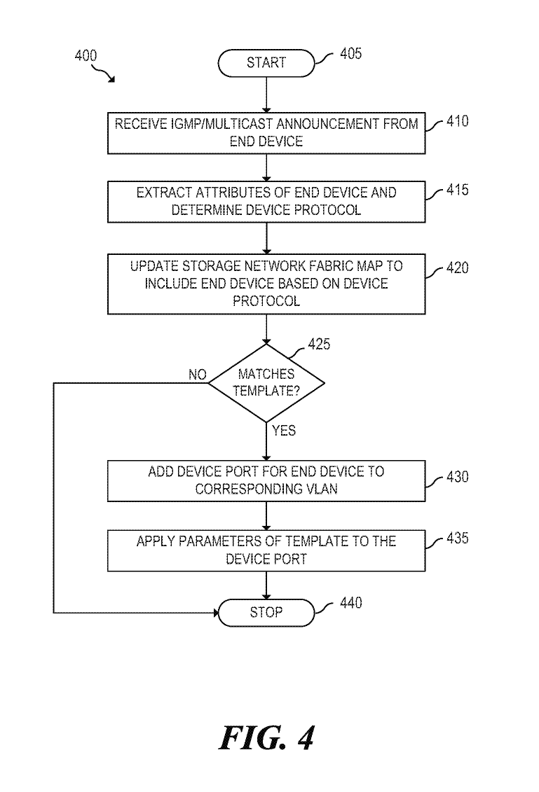

FIG. 4 is a flowchart of an example method 400 for execution by a SDN controller 202 for enabling auto-configuration and management of a software defined network. Although execution of method 400 is described below with reference to SDN controller 202 of FIG. 2, other suitable devices for execution of method 400 may be used. Method 400 may be implemented in the form of executable instructions stored on a machine-readable storage medium and/or in the form of electronic circuitry.

Method 400 may start in block 405 and continue to block 410, where SDN controller 202 receives an IGMP/multicast announcement from an end device. In block 415, networking device extracts attributes (e.g., device type, device protocol, etc.) associated with the end device from the IGMP/multicast announcement. In block 420, SDN controller 202 updates a storage network fabric map based on the device protocol and/or type to include the end device. The storage fabric map may also he updated based on various other parameters extracted from the IGMP/multicast announcement. Because the SDN controller 202 knows the device protocol of the end device, the fabric map is appropriately updated based on the properties of the end device.

In block 425, SUN controller 202 determines if the attributes of the end device matches a policy template. For example, each storage protocol can have a corresponding policy template that specifies networking parameters for all the devices in that network controlled by SDN. In other examples, other attributes such as protocols supported by the end device can also be used to determine if there is matching policy. If the attributes of the end device do not match a policy template, method 400 continues to block 440 and stops. If the attributes of the end device do match a policy template, a device port for the end device is added to a corresponding VLAN in block 430. In block 435, SDN controller 202 applies parameters of the policy template to the device port. Method 400 may then continue to block 440, where method 400 may stop.

The foregoing disclosure describes a number of examples for enabling auto-configuration and management of storage resources. In this manner, the examples disclosed herein facilitate auto-configuration and management of a storage area network by using an SUN controller that can handle IGMP/multicast announcements to automatically manage the storage area network.

We claim:

1. A networking device for auto-configuration and management of storage resources, comprising:
a memory comprising a storage network fabric map that describes a network topology of a plurality of end devices in a software defined network (SDN);
an SDN controller operatively connected to the memory, the SDN controller to:
receive an Internet group management protocol (IGMP)/multicast announcement from an end device of the plurality of end devices;
update the storage network fabric map to include the end device based on the IGMP/multicast announcement;
add a device port of the end device to a virtual local area network (VLAN); and
in response to determining that the end device matches a policy template, apply a plurality of parameters of the template policy to the device port.

2. The networking device of claim 1, wherein the plurality of parameters comprises at least one parameter of a group consisting of quality of service, security, diagnostics, zoning profile, and access control list (ACL) to the device port.

3. The networking device of claim 1, wherein the plurality of end devices comprises a plurality of storage devices and a plurality of server devices, and wherein each of the plurality of server devices accesses the plurality of storage devices over the SDN.

4. The networking device of claim 1, wherein the SDN controller is further to extract a device type of the end device from the IGMP/multicast announcement, wherein the device type is used to update the storage network fabric map.

5. The networking device of claim 1, wherein the SDN controller is further to extract a device protocol of the end device from the IGMP/multicast announcement, wherein the device protocol is used to update the storage network fabric map.

6. The networking device of claim 5, wherein the VLAN is selected from a plurality of VLAN's based on the device protocol.

7. A method for auto-configuration and management of storage resources, comprising:
receiving an Internet group management protocol (IGMP)/multicast announcement from an end device of a plurality of end devices;
extracting a device protocol of the end device from the IGMP/multicast announcement;
updating the storage network fabric map to include the end device based on the device protocol, wherein the storage fabric map describes a network topology of the plurality of end devices in a software defined network (SDN);
adding a device port of the end device to a virtual local area network (VLAN) associated with the device protocol; and
in response to determining that the end device matches a policy template, applying a plurality of parameters of the template policy to the device port.

8. The method of claim 7, wherein the plurality of parameters comprises at least one parameter of a group consisting of quality of service, security, diagnostics, zoning profile, and access control list (ACL) to the device port.

9. The method of claim 7, wherein the plurality of end devices comprises a plurality of storage devices and a plurality of server devices, and wherein each of the plurality of server devices accesses the plurality of storage devices over the SDN.

10. The method of claim 7, further comprising extracting a device type of the end device from the IGMP/multicast announcement, wherein the device type is used to update the storage network fabric map.

11. The method of claim 7, wherein the VLAN is selected from a plurality of VLAN's based on the device protocol.

12. A non-transitory machine-readable storage medium encoded with instructions executable by a processor for auto-configuration and management of storage resources, the machine-readable storage medium comprising instructions to:
receive an Internet group management protocol (IGMP)/multicast announcement from an end device of a plurality of end devices;
extract a device protocol of the end device from the IGMP/multicast announcement;
update the storage network fabric map to include the end device based on the device protocol, wherein the storage fabric map describes a network topology of the plurality of end devices in a software defined network (SDN);
add a device port of the end device to a virtual local area network (VLAN) associated with the device protocol, wherein the VLAN is selected from a plurality of VLAN's based on the device protocol; and
in response to determining that the end device matches a policy template, apply a plurality of parameters of the template policy to the device port.

13. The non-transitory machine-readable storage medium of claim 12, wherein the plurality of parameters comprises at least one parameter of a group consisting of quality of service, security, diagnostics, zoning profile, and access control list (ACL) to the device port.

14. The non-transitory machine-readable storage medium of claim 12, wherein the plurality of end devices comprises a plurality of storage devices and a plurality of server devices, and wherein each of the plurality of server devices access the plurality of storage devices over the SDN.

15. The non-transitory machine-readable storage medium of claim 12, wherein the instructions are further to extract a device type of the end device from the IGMP/multicast announcement, wherein the device type is used to update the storage network fabric map.
